(19) United States
(12) Patent Application Publication
(10) Pub. No.: US 2010/0095798 A1
(43) Pub. Date: Apr. 22, 2010

(54) PLANAR MOVING APPARATUS

(75) Inventors: LIANG CHIH CHANG, Hsinchu City (TW); CHAO JUNG CHEN, Taoyuan County (TW); CHYAN CHYI WU, Taipei County (TW); SHENG HANG WANG, Hsinchu City (TW); TA CHANG YU, Kaohsiung City (TW); CHUNG LUN WU, Chiayi County (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, Hsinchu (TW)

(21) Appl. No.: 12/417,208

(22) Filed: Apr. 2, 2009

(30) Foreign Application Priority Data
Oct. 16, 2008 (TW) 097139664

(51) Int. Cl. G05G 3/00; G05G 25/00

(52) U.S. Cl. 74/479.01

(57) ABSTRACT

A planar moving apparatus includes a moving stage, a first driving apparatus, a second driving apparatus and a base member. The base member carries the stage, the first driving apparatus and the second driving apparatus. The first driving apparatus drives the moving stage along a first axial direction and the second driving apparatus drives the moving stage along a second axial direction. The first driving apparatus and the second driving apparatus operate independently and do not interfere with each other when the moving stage moves along either the first axial direction or the second axial direction.

### BACKGROUND OF THE INVENTION

(A) Field of the Invention

The present invention is related to a planar moving apparatus.

(B) Description of the Related Art

Current planar moving apparatuses normally need two axial guides and two moving stages, in which the two axial guides are overlapped, and one axis guide is carried by another axis guide. For instance, for a three-dimensional or auto optical detection system using an overlapped planar moving apparatus, the size of apparatus may be large, so that its positioning control may be more difficult.

At present, the moving mechanism of the planar moving apparatus is of an overlapped type, and one axis has to load the other axis.

Greater mechanical accuracy is needed in industry; current technology for overlapped planar moving mechanism does not meet the requirements.

### SUMMARY

The present invention provides a planar moving apparatus to overcome the problems of an overlapped moving apparatus.

In accordance with an embodiment of the present invention, a planar moving apparatus includes a moving stage, a first driving apparatus, a second driving apparatus, and a base member. The base member carries the moving stage, the first driving apparatus and the second driving apparatus and these two driving apparatuses operate independently. The first driving apparatus drives the moving stage along a first axial direction and the second driving apparatus drives the moving stage along a second axial direction. The first driving apparatus and the second driving apparatus operate independently and do not interfere with each other when the moving stage moves along the first axial direction and the second axial direction.

### BRIEF DESCRIPTION OF THE DRAWINGS

FIG. 1 shows a three-dimensional view of a planar moving apparatus in accordance with an embodiment of the present invention;

FIG. 2 shows a side view of the planar moving apparatus in FIG. 1;

FIG. 3 shows a three-dimensional view of a planar moving apparatus in accordance with another embodiment of the present invention;

FIG. 4 shows the guides of the planar moving apparatus in FIG. 3;

FIG. 5 shows the top view of a planar moving apparatus in accordance with an embodiment of the present invention; and

FIG. 6 shows the top view of a planar moving apparatus in accordance with another embodiment of the present invention.

### DETAILED DESCRIPTION OF THE EMBODIMENTS

The embodiments of the present invention will be explained with the appended drawings.

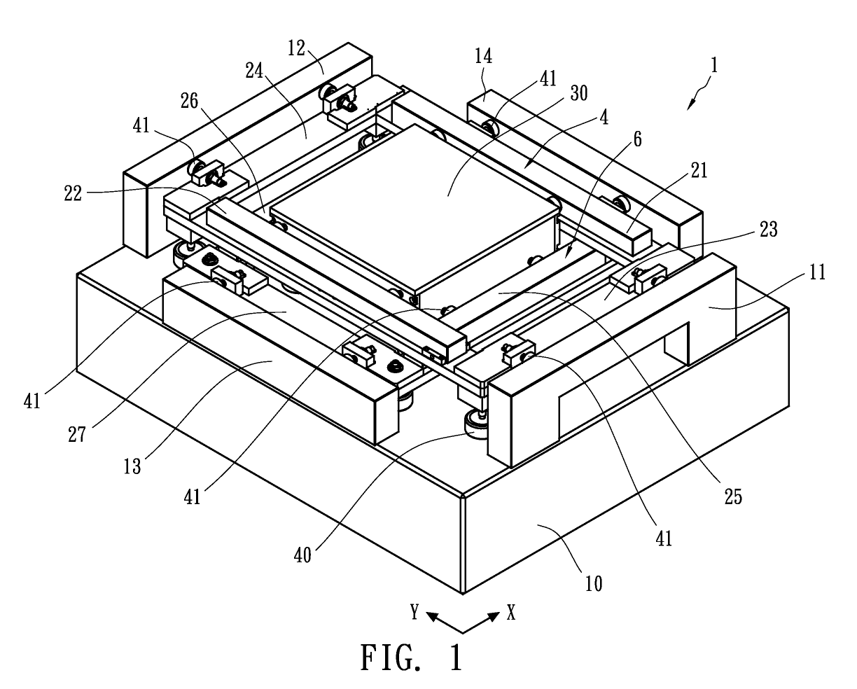

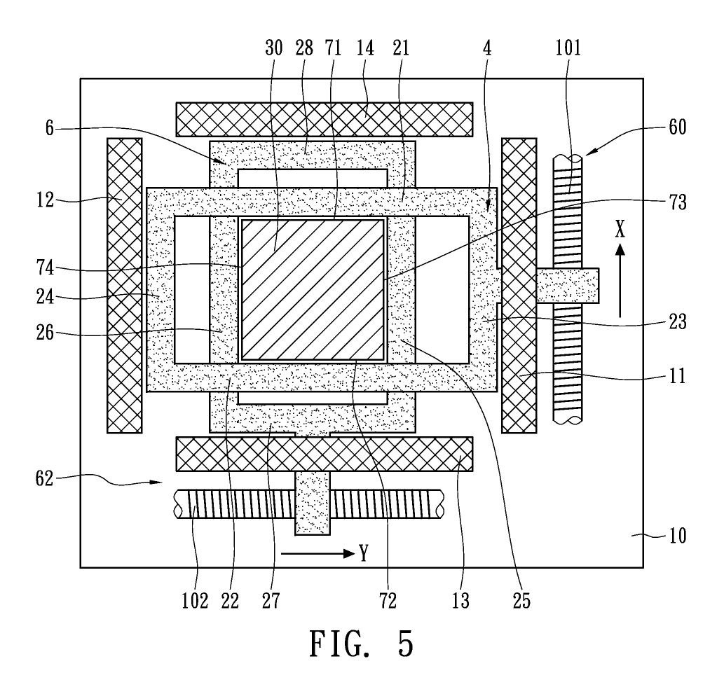

FIG. 1 shows a three-dimensional view of a planar moving apparatus 1 in accordance with an embodiment of the present invention. Four orthogonal guides 11, 12, 13 and 14 are formed on a base member 10, e.g., a granite base, and two independent frames 4 and 6 are formed within the area enclosed by the four guides 11, 12, 13 and 14. The frames 4 and 6 may be rectangular and each can be completely one part. For explanation, it is illustrative that the frame 4 includes four side bars 21, 22, 23 and 24, and the frame 6 includes four side bars 25, 26, 27 and 28. The side bar 28 opposite to the side bar 27 of the frame 6 is placed below and covered by the side bar 21 of frame 4, so that the side bar 28 is not shown in FIG. 1. The corresponding top view is shown in FIG. 5, illustrating the position of the side bar 28. The four side bars of the frames 4 and 6 are orthogonal and form rectangular structures. The frame 4 moves along the X-axis and is restricted by the guides 11 and 12 in the Y-axis direction, i.e., the guides 11 and 12 prohibit the frame 4 from moving along the Y-axis direction. The frame 6 moves along the Y-axis and is restricted by the guides 13 and 14 in the X-axis direction, i.e., the guides 13 and 14 prohibit the frame 6 from moving along the X-axis direction. The moving stage 30 is enclosed by the frames 4 and 6, and the two frames 4 and 6 restrict the planar moving range of the moving stage 30.

In an embodiment, air bearings 41 are provided between the four sides of the moving stage 30 and the side bars 21 and 22 of the frame 4 and the side bars 25 and 26 of the frame 6, so that the frame 4 and the frame 6 can push the moving stage 30 through air bearings 41 and the side bars 21, 22 and the side bars 25, 26 push the moving stage 30 along the X-axis and Y-axis, respectively. Moreover, air bearings 41 may be disposed between the side bar 23 and 24 of the frame 4 and the guides 11 and 12, and air bearings 41 may be disposed between the side bar 27 and 28 of the frame 6 and the rails 13 and 14 also. As a result, the movements between the frames 4, 6 and the guides 11, 12, 13 and 14 are via the air bearings 41. More specifically, the side bars 21 and 22 of frame 4 serving as pushers push the moving stage 30 forward and backward along the X-axis direction through air bearings 41. The side bars 25 and 26 of frame 6 serving as pushers push the moving stage 30 forward and backward along the Y-axis direction through air bearings 41. The air bearings 41 are disposed between the frames 4, 6 and the guides 11, 12, 13 and 14 as moving interfaces therebetween.

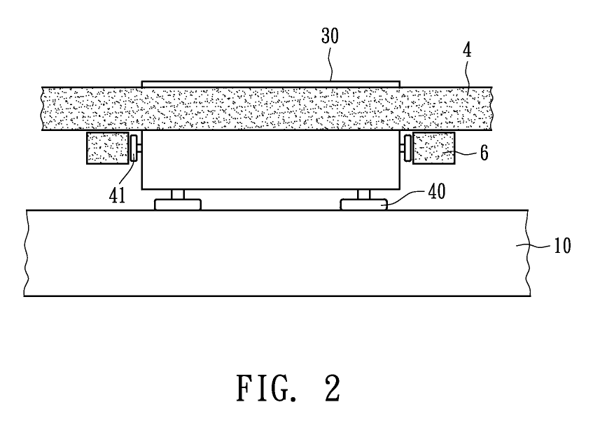

FIG. 2 shows a side view of the planar moving apparatus 1. The frame 4 and the frame 6 are placed at different heights. In this embodiment, the frame 4 is placed above the frame 6, so that the corresponding pushing positions of the air bearings 41 on the moving stage 30 are different. Accordingly, regardless of the movement of the moving stage 30 along the X-axis direction or the Y-axis direction, the frame 4 and the frame 6 do not interfere with each other. In addition to the placement of the air bearings 41 between the moving stage 30 and the frames 4 and 6, the air bearings 40 also can be placed between the moving stage 30 and the base member 10 to support the frames 4, 6 and the moving stage 30.

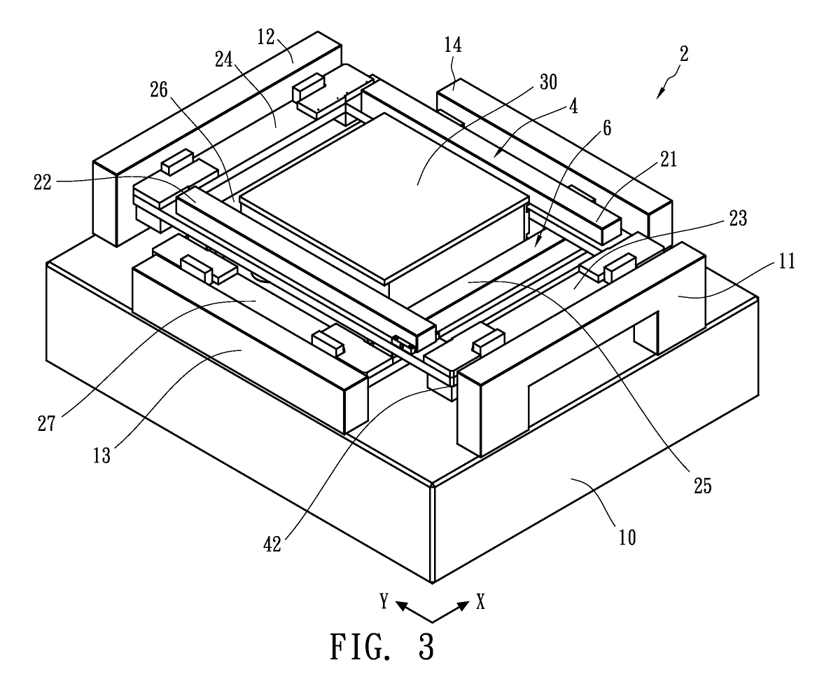

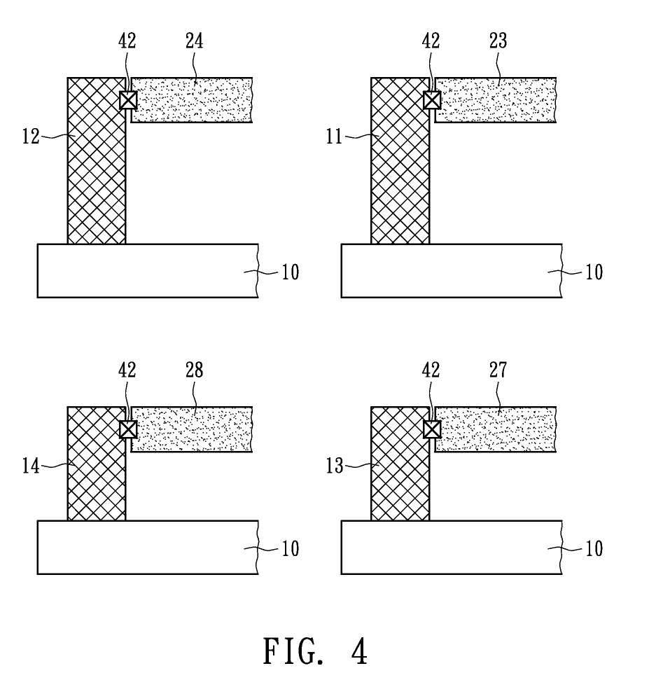

FIG. 3 shows a planar moving apparatus 2 in accordance with another embodiment of the present invention. In this structure, ball bearings or linear guides are used instead of the air bearing. Similar to the planar moving apparatus 1, four orthogonal guides 11, 12, 13 and 14 are formed on a base member 10, and two independent frames 4 and 6 are formed within the area enclosed by the four guides 11, 12, 13 and 14. The frame 4 has four sides 21, 22, 23 and 24 and the frame 6 has four sides 25, 26, 27 and 28. The side bar 28 opposite to the side bar 27 of the frame 6 is placed below and covered by the side bar 21 of frame 4, so that the side bar 28 is not shown in FIG. 3. The corresponding top view is shown in FIG. 5, illustrating the position of the side bar 28. The four side bars of each of the frames 4 and 6 are orthogonal. The frame 4 moves along the X-axis and is restricted by the guides 11 and 12 in the Y-axis direction. The frame 6 moves along the Y-axis and is restricted by the guides 13 and 14 in the X-axis direction. The moving stage 30 is enclosed by the frames 4 and 6, and the two frames 4 and 6 restrict the planar moving range of the moving stage 30. In this embodiment, the moving mechanism of the side bar and the corresponding guides is shown in FIG. 4, in which ball bearings or linear guides 42 are formed between the side bars 23 and 24 of the frame 4 and the guides 11 and 12, and ball bearings or linear guides 42 are formed between the side bars 27 and 28 and the guides 13 and 14, thereby allowing the frame 4 to move between the guides 11 and 12 along the X-axis direction, and the frame 6 can move between the guides 13 and 14 along the Y-axis direction. In this embodiment, the ball bearings or linear guides are used in place of the air bearings.

FIG. 5 shows a top view of a planar moving apparatus in accordance with an embodiment of the present invention. To clearly illustrate the features of the present invention, only main components are shown in FIG. 5. In FIG. 5, some portions of the frame 4 are overlapped above the frame 6, i.e., the frames 4 and 6 have different heights. Therefore, when the side bars 21 and 22 of the frame 4 push the moving stage 30 along the X-axis direction, or the side bars 25 and 26 of the frame 6 push the moving stage 30 along the Y-axis direction, the frames 4 and 6 operate independently and do not interfere with each other. In an embodiment, the movement of the moving stage 30 along the X-axis direction is driven by a lead screw 101, and the movement of the moving stage 30 along the Y-axis direction is driven by a lead screw 102. The lead screws 101 and 102 operate independently and are securely placed on the base member 10. The inner width of frame 4 in the Y-axis direction is greater than the width of the moving stage 30 in the same direction. The inner width of frame 6 in the X-axis direction is greater than the width of the moving stage 30 in the same direction. In addition to the use of air bearings between four sides 71, 72, 73 and 74 and side bars 21, 22, 25 and 26, ball bearings or linear guides can also be used.

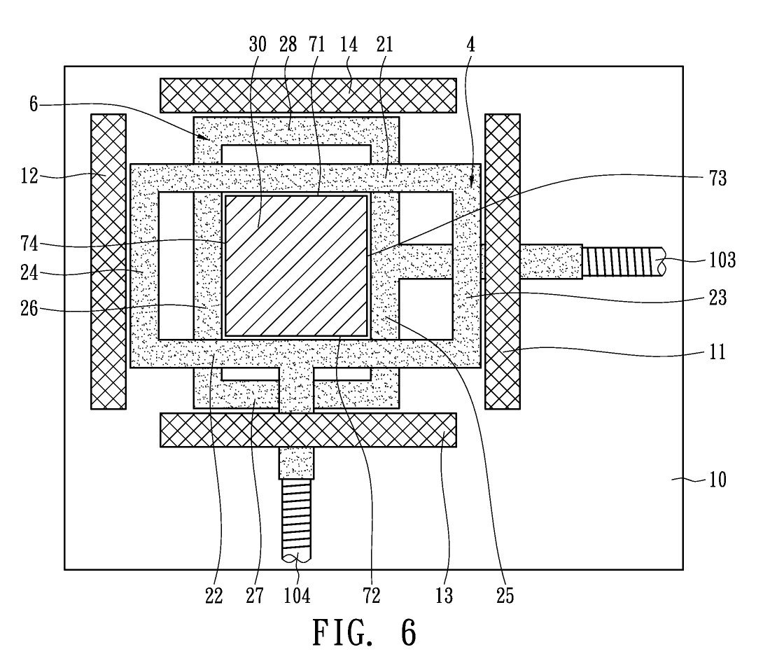

Referring to FIG. 6, unlike the lead screws 101 and 102 shown in FIG. 5, the lead screw 104 of the frame 4 and the lead screw 103 of the frame 6 drive in the middle of the frames.

In summary, the frame 4, the guides 11, 12 and the lead screw 101 form a first driving apparatus 60 that drives the moving stage 30 along the X-axis direction with the guidance of the guides 11 and 12. The frame 6, the guides 13, 14 and the lead screw 102 form a second driving apparatus 62 that drives the moving stage 30 along the Y-axis direction with the guidance of the guides 13 and 14.

The planar moving apparatus is a two-frame and one-moving stage architecture, and the moving stage moves along the X-axis direction and the Y-axis direction. The movement of the moving stage along the X-axis direction is restricted by two parallel guides including air bearings, or ball bearings, or linear guides at two opposite sides of a frame, and the movement of the moving stage along the Y-axis direction is restricted by two parallel guides including air bearings, or ball bearings, or linear guides at two opposite sides of another frame, so as to ensure the accuracy. By the design of two-frame and a single moving stage and the use of ball bearings, linear guides and air bearings between the base member, the guides and the moving stage, the movements of the moving stage along the X-axis direction and the Y-axis direction are in a same plane. Accordingly, the impact of different heights of the two axes when positioning can be tremendously decreased. According to the design of the two-frame and a single moving stage, the driving apparatuses of the two axes can be independently fixed on the base member. The use of two frames to push the moving stage provides superior rigidity and accuracy, and can be used for nano-applications. In consideration of the need for better planar accuracy for guides, the guides can be made of granite. The planar moving apparatus of the present invention can be applied to semiconductor steppers, super accurate positioning and moving apparatuses and various optical detecting apparatuses for nano-applications.

According to the above embodiments, the frames are used to drive the moving stage. However, other variations that use independent pushers to move the moving stage along different axes without interference are still covered by the scope of the present invention.

The above-described embodiments of the present invention are intended to be illustrative only. Numerous alternative embodiments may be devised by those skilled in the art without departing from the scope of the following claims.

What is claimed is:

1. A planar moving apparatus, comprising:
a moving stage;
a first driving apparatus configured to drive the moving stage to move along a first axial direction;
a second driving apparatus configured to drive the moving stage to move along a second axial direction; and
a base member carrying the stage, the first driving apparatus and the second driving apparatus;
wherein the first driving apparatus and the second driving apparatus operate independently and do not interfere with each other when the moving stage moves along either the first axial direction or the second axial direction.

2. The planar moving apparatus in accordance with claim 1, wherein the first axial direction and the second axial direction are orthogonal.

3. The planar moving apparatus in accordance with claim 1, wherein the first driving apparatus comprises a first pusher and a second pusher for respectively pushing a first side and a second side opposite to the first side of the moving stage, thereby moving the moving stage along the first axial direction.

4. The planar moving apparatus in accordance with claim 3, wherein the second driving apparatus comprises a third pusher and a fourth pusher for respectively pushing a third side and a fourth side opposite to the third side of the moving stage, thereby moving the moving stage along the second axial direction, the first and the second pushers moving at a height that is different from a height of the third and fourth pushers.

5. The planar moving apparatus in accordance with claim 4, wherein the heights of the moving stage pushed by the first and second pushers are different from the heights of the moving stage pushed by the third and fourth pushers.

6. The planar moving apparatus in accordance with claim 3, wherein the first pusher and the second pusher are included in a first frame.

7. The planar moving apparatus in accordance with claim 4, wherein the third pusher and the fourth pusher are included in a second frame.

8. The planar moving apparatus in accordance with claim 1, wherein the moving stage is supported by the base member with air bearings.

9. The planar moving apparatus in accordance with claim 1, wherein the first driving apparatus comprises a first frame having a first side bar and a second side bar opposite to the first side bar, and the first side bar and the second side bar respectively push a first side and a second side opposite to the first side of the moving stage, thereby moving the moving stage along the first axial direction.

10. The planar moving apparatus in accordance with claim 9, wherein the second driving apparatus comprises a second frame having a third side bar and a fourth side bar opposite to the third side bar, and the third side bar and the fourth side bar respectively push a third side and a fourth side opposite to the third side of the moving stage, thereby moving the moving stage along the second axial direction.

11. The planar moving apparatus in accordance with claim 10, wherein the first frame and the second frame move at different heights and do not interfere with each other.

12. The planar moving apparatus in accordance with claim 10, wherein the inner width of the first frame is larger than the width of the moving stage along the second axial direction, and the inner width of the second frame is larger than the width of the moving stage along the first axial direction.

13. The planar moving apparatus in accordance with claim 10, wherein the first frame and the second frame push the moving stage through air bearings, or ball bearings, or linear guides.

14. The planar moving apparatus in accordance with claim 10, wherein the first driving apparatus further comprises first guides guiding the first frame to move along the first axial direction, and the second driving apparatus further comprises second guides guiding the second frame to move along the second axial direction.

15. The planar moving apparatus in accordance with claim 14, wherein movements between the first guides and the first frame and is between the second guides and the second frame are via air bearings, or ball bearings, or linear guides.

16. The planar moving apparatus in accordance with claim 14, wherein the first guides are placed at two sides of the first frame and prohibit the first frame from moving along the second axial direction, and the second guides are placed at two sides of the second frame and prohibit the second frame from moving along the first axial direction.

17. The planar moving apparatus in accordance with claim 14, wherein the first driving apparatus further comprises a first lead screw driving the first frame to move along the first axial direction, and the second driving apparatus further comprises a second lead screw driving the second frame to move along the second axial direction.
